(19) United States
(12) Patent Application Publication
(10) Pub. No.: US 2012/0249551 A1
(43) Pub. Date: Oct. 4, 2012

(54) ALIGNMENT OF SHAPES OF BODY PARTS FROM IMAGES

(75) Inventors: Konstantin Chernoff, Rodovre (DK); Mads Nielsen, Dragor (DK); Martin Lillholm, Niva (DK)

(73) Assignee: SYNARC INC., Newark, CA (US)

(21) Appl. No.: 13/377,313

(22) PCT Filed: Jun. 3, 2010
(86) PCT No.: PCT/EP10/57765

§ 371 Date: Jun. 20, 2012

Related U.S. Application Data
(60) Provisional application No. 61/268,370, filed on Jun. 11, 2009.

(51) Int. Cl. G06T 17/00

(52) U.S. Cl. 345/420

(57) ABSTRACT

A method of manipulation of a representation of a 2-D shape for improving a General Procrustes Alignment process, comprising taking a starting 2-D shape defined by a set of landmarks derived from data representing a 2-D projection image of a body part such as a vertebra, in a suitably programmed computing device deriving for each landmark of the 2-D shape a probable relative depth by the application thereto of a statistical model based on a multiplicity of 3-D shapes defined by landmarks derived from 3-D images of similar said body parts, said landmarks having one depth and two spatial coordinates, said model relating the probable relative depth of each landmark in a 3-D-shape of a said body part to the spatial coordinates of the set of landmarks constituting a said shape, and based on the inferred relative depth of the landmarks of the starting 2-D shape deforming the starting 2-D shape to correct for apparent distortion caused by rotation about an axis parallel to the projection plane of the imaged body part, so producing a corrected 2-D shape.

The present invention relates to improvements in alignment methods for aligning shapes of body parts extracted from images, for instance improvements in generalised Procrustes alignment techniques applied to images of similar body parts, e.g. joints or bones such as for instance vertebrae.

WO2006/087190 disclosed methods of deriving an estimate of the extent of fracture in a vertebra shown in an image of part of a spine using statistical mathematical techniques involving comparison of the image with a statistical shape model built from images of many spines.

WO2008/141996 described a semi-automatic method for segmenting an image of part of a spine, i.e. for finding the edge contours of vertebrae shown in the image. This also involved applying to the image under study a mathematical model built from similar images of many spines.

PCT/EP2009/054294 described methods of estimating the risk of an imaged spine fracturing at some future time by applying to an image of the spine a statistical mathematical model based on images of spines in an unfractured state which were known to fracture or not to fracture in the future, and classifying the spine under study.

These are merely examples of how a statistical shape model of a spine, built from information relating to many spines, can be used to derive useful information from an image of a spine under study.

Common to all of these described methods is an initial stage in the construction of the statistical shape model, which is the adjustment of the many images so that they are adjusted for differences in scale or angle of view whilst seeking to preserve the relevant differences between the images. This adjustment is carried out in each of the above examples by a mathematical procedure known as generalised Procrustes alignment.

Thus, many imaging devices, such as X-ray, both single energy X-ray absorptiometry and dual energy X-ray absorptiometry (DXA), and various microscopy and optical images modalities, output 2-D projections of the world.

However, the scanned objects are usually 3-D, and their 2-D projections will generally be influenced by the relative orientation to the image plane.

Before performing shape analysis, the acquired shapes must be aligned in a global coordinate system. In this context, the alignment involves changing the scale, translation, and orientation. Traditionally, this type of alignment is achieved by performing Generalized Procrustes Alignment (GPA).

GPA is described in the above publications and more generally in Gower and in Goodall.

There are numerous different algorithms known for performing such a procedure. Generally however, they seek to maximise the similarity of images of similar objects by adjusting the images to remove the effects of location, rotation in the plane of the image and scale. Procrustes analysis is therefore a rigid shape analysis that uses isomorphic scaling, translation, and rotation to find the “best” fit between two or more landmarked shapes. Thus, conceptually a typical algorithm for generalized orthogonal Procrustes analysis might be:
1. Select one shape to be the approximate mean shape (i.e. the first shape in the set).
2. Rigidly align the shapes to the approximate mean shape.
   a. Calculate the centroid of each shape (or set of landmarks).
   b. Align all shapes centroid to the origin.
   c. Normalize each shapes centroid size.
   d. Rotate each shape to align with the newest approximate mean.
3. Calculate the new approximate mean from the aligned shapes.
4. If the approximate mean from steps 2 and 3 are different the return to step 2, otherwise terminate.

Once this has been done, the similarities and differences in the individual aligned images can be used to derive useful statistical information as described for instance in the above references.

Generally, shape analysis consists of identifying and parametrizing the significant degrees of freedom in a collection of shapes [Cootes et al 1992]. This is accomplished by aligning the shapes according to some metric and possibly projecting them onto a low dimensional manifold. Traditionally, the shapes are represented by landmarks, Generalized Procrustes Alignment (GPA) is used to align the shapes, and Principal Component Analysis (PCA) is used to reduce the dimensionality. This approach is often referred to as a Point Distribution Model (PDM) [Cootes 1999].

Once constructed, the shape models can be combined with search algorithms and be used to extract semantic information from images. Some of the most popular applications of shape models include the Active Shape Model (ASM) and Active Appearance Model (AAM) [Cootes 1999]. Both of these methods are popular and have given rise to much progress in medical image processing [Cootes and Taylor 1994].

Furthermore, both ASM and AAM have been the basic tools for modelling and segmenting the human vertebrae in single energy X-rays and DXA images. Basic ASM [Smyth et al 1999], ASM with a non-parametric pixel classifier [de Bruijne et al 2004], a modified AAM constrained by neighbouring vertebrae [Roberts et al], and a similar model based only on shape information [de Bruijne et al 2007], have been successfully applied.

Several approaches have been introduced to improve the precision and the accuracy of the shape models. Most of these approaches are based on using other dimensionality reduction methods than PCA, modifying the GPA, or modifying the point matches [Davies et al 2001].

Due to the large field of dimensionality reduction, it is natural to use other methods than PCA when modelling shape variation. This includes Kernel-PCA [Rohdhani et al 1999], Principal Geodesic Analysis [Dam et al 2004], Independent Component Analysis (ICA) [Üzümcü et al 2003], and Locally Linear Embeddings [Elgammal 2004]. In situations where outliers are present, robust dimensionality reductions methods can be utilized. Such an approach was taken in [Iglesias et al 2007] where a robust version of PCA called Φ-PCA was used.

Several modifications of the traditional GPA are possible. According to Larsen et al 2001, Seigel et al 1992 made GPA robust by using medians when calculating the scale, translation, and orientation of objects. In [Larsen et al 2008], L1 norm was used when computing shape similarity. Furthermore, functional GPA [Larsen et al 2005] can be used on occasions where it is more appropriate to maximize the similarity between contours instead of landmarks.

Another logical step to improve the performance of GPA is to incorporate the 3-D information that inherently existed when the 2-D shapes were created. When several shapes of the same object are available, 3-D reconstruction techniques can be used to reconstruct the 3-D shapes [Benameur et al 2003]. The reconstructed 3-D shapes could potentially be used to guide the alignment of the 2-D shapes. In terms of medical image processing, this approach would require multiple overlapping X-rays or a CT scan, However, such data may be expensive when compared to the cost of a single X-ray.

Another approach that accounts the 3-D orientation was introduced by Buxton et al. [Buxton et al 2005]. Their approach represented a set of shapes by using Centred Affine Trifocal Tensors (CATT) to calculate two sets of aligned basis shapes. However, since both 3-D and 2-D shapes must be inferred from the data set, much more data must be available when compared to approaches only inferring the 2-D shape variations.

We now propose to improve the GPA by taking into account the influence on the 2-D starting images of the rotational aspect of the imaged object with respect to rotation out of the image plane or 2-D projection plane. In what follows, we divide the methodology in two: first we infer 3-D information in an independent 3-D data set then we infer the 2-D apparent deformation based on the inferred 3-D information.

There is therefore now provided according to a first aspect of the invention, taking a starting 2-D shape defined by a set of landmarks derived from data representing a 2-D projection image of a body part, in a suitably programmed computing device deriving for each landmark of the 2-D shape a probable relative depth by the application thereto of a statistical model based on a multiplicity of 3-D shapes defined by landmarks derived from 3-D images of similar said body parts, said landmarks having one depth and two spatial coordinates, said model relating the probable relative depth of each landmark in a 3-D-shape of a said body part to the spatial coordinates of the set of landmarks constituting a said shape, and based on the inferred relative depth of the landmarks of the starting 2-D shape deforming the starting 2-D shape to correct for apparent distortion caused by rotation about an axis parallel to the projection plane of the imaged body part, so producing a corrected 2-D shape.

Such a method may be employed in the context of a method according to the second aspect of the invention which provides: a method of mathematical alignment of a set of 2-D shapes, each shape being defined by a set of landmarks derived from a 2-D projection image of a similar body part, said method comprising in a suitably programmed computing device:
(a) executing an algorithm-on the set of shapes to define a reference shape being a mean of said shapes aligned with respect to at least one of translation, scaling and rotation within an image projection plane;
(b) for each shape in the set of 2-D shapes, inferring the relative depth of each landmark which is dependent on the extent of rotation of the body part that has been imaged to produce the shape about an axis parallel to the image projection plane, said inference being carried out by
   (b1) deriving for each landmark of the 2-D shape a probable relative depth by the application thereto of a statistical model based on a multiplicity of 3-D shapes defined by landmarks derived from 3-D images of similar said body parts, said landmarks having one depth and two spatial coordinates, said model relating the probable relative depth of each landmark in a 3-D-shape of a said body part to the spatial coordinates of the set of landmarks constituting a said shape
(c) based on the inferred relative depth of the landmarks of each of the 2-D shapes deforming the 2-D shape to correct for apparent distortion caused by rotation of the imaged body part about an axis parallel to the projection plane
(d) executing an algorithm to align the corrected shapes,
(e) calculating a corrected reference shape, being the mean of the corrected shapes and aligning the corrected reference shape with the preceding reference shape to produce a new reference shape,
(f) comparing the new reference shape with the preceding reference shape and repeating from step (b) until such comparison shows that the new reference shape and the preceding reference shape are close to being the same within a predetermined limit, and so obtaining a set of 2-D-shapes aligned with respect to translation, scaling, rotation within the projection plane and rotation out of the projection plane.

Optionally, step (a) can itself be conducted as an iterative process in which the aligned shapes are realigned to the mean shape and a new mean shape is calculated based on the realigned shapes in each iteration. The iterative process can be conducted until differences between successive mean shapes are sufficiently small within a predetermined limit. There may be a predetermined number of iterations employed. This is described below in greater detail in relation to step (f), but what is said there applies equally to step (a).

The 3-D shapes may be derived from data representing respective 3-D images, but may alternatively be derived from 3-D body parts otherwise than by imaging, for instance by physical measurement of sample body parts, such as a collection of vertebrae. One suitable method of measurement would be laser scanning such objects.

The ‘relative depth’ of a landmark point in a 2-D projection image of a body part is the relative depth of the point on the 3-D body part that projects to produce that landmark point. Relative depth in this sense is relative to any chosen plane of reference and is without units or has arbitrary units, being the degree by which any one point on the body part is further from the reference plane than another.

The iteration carried out in step (f) (and equally the optional iteration in step (a)) may be pursued to produce new and preceding reference shapes that are sufficiently similar according to any predetermined criterion of similarity which is judged to be sufficient in the circumstances, as known in the art. For instance, one may compare the new and preceding reference shapes and continue until the difference is judged to be sufficiently small, for instance by determining that the sum of squared errors is below a predefined threshold ε as a stopping criterion. Suitably, ε may be from 10⁻⁵ to 10⁻¹², for instance from 10⁻⁸ to 10⁻¹¹, e.g. about 10⁻¹⁰. Alternatively, the predetermined degree of similarity of the new reference shape and the preceding reference shape can be decided in advance to be that which is achieved by a set number of iterations, for instance from 25 to 500, more preferably 50 to 200, e.g. about 100 iterations. The number of iterations necessary in any particular instance can be learnt from experience by comparing the new reference shape and the preceding reference shape after various numbers of iterations to measure the degree of difference between them or by conducting iterations measuring the degree of difference each time until the measured degree of difference is judged to be sufficiently small, and using the number of iterations that achieved that difference on future occasions.

Optionally in the method according to the first aspect of the invention, or in step b1 of the method of the second aspect, a separate statistical model is used for each landmark of the 2-D shape. An alternative is to estimate the full covariance using regularised estimates such as ridge regression, Bayes-PCA or MAP-PCA, further described below.

Optionally, the statistical model is a conditional Gaussian model.

The probable relative depth of each landmark of the 2-D shape is preferably based on the covariance matrix of the spatial landmark coordinates of the multiplicity of 3-D shapes. The covariance matrix may be estimated for this purpose in a number of ways. Where there is sufficient data, this may be a straightforward maximum likelihood estimate. In other cases more robust covariance matrix estimates may be obtained by regularisation. Methods used may include ridge regression, Bayes-PCA, or MAP-PCA (see Tipping et al and Crimi et al respectively). In step (d), the 2-D shapes may be corrected for deformation produced by rotation of the imaged body part by adjusting the 2-D spatial coordinates of each landmark according to its calculated probable relative depth.

In order to be alignable, it will generally be the case that the body parts in question are of a similar nature so that they can meaningfully be aligned. Suitably, each body part in said images is a bone, a joint, or a part of a joint including at least a part of at least one bone. Each image is preferably taken in a standardised manner in order to show the relevant body part so far as practicable in the same orientation, but the invention is of course intended to accommodate variations of that kind in so far as they are not avoided. Although the body parts making up the set of images may be similar, they need not be fully identical. For instance, if the images are of vertebrae, they may not all be images of the corresponding vertebra from different individuals. Thus if the images show vertebrae L1 to L4, for instance, one may use all of those in the set or construct four separate sets, one for the L1 vertebrae, one for the L2s and so forth.

Images of finger joints similarly may all relate to corresponding fingers of different individuals or in some cases it may be useful to include in the set images of different finger joints. Images of knees may be limited to a set of images of left knees or right knees or may involve both (suitably with mirror image reversal of one class) and the same is true generally of body parts that exist as a left and right pair.

Optionally in step (b) one may infer the relative depth of each landmark taking into account rotation of the body part about more than one axis parallel to the image projection plane, e.g. two orthogonal axes.

The invention includes carrying out an alignment as described and then deriving at least one prognostic, diagnostic or efficacy biomarker in respect of a new 2-D shape of a corresponding body part by comparison of the new shape with the aligned shapes. A prognostic biomarker provides information as to whether the new imaged body part is indicative of a raised probability of developing a disease state in the future. A diagnostic biomarker provides information as to whether the new imaged body part is indicative of a raised probability of an existing disease state, and its severity. An efficacy marker provides information as to whether a therapeutic treatment has improved a previously existing disease state.

The comparison of the new shape with the aligned shapes may be performed using directly the data defining the 2-D aligned shapes and similar data defining the new shape (optionally after aligning the new shape to the mean of the aligned shapes). For instance, where the shapes are of vertebrae, one might establish a correlation between the known degree of fracture of the respective aligned shapes and a numerical parameter such as the ratio of different vertebral heights and then determine where in the resulting scale a new vertebra fitted.

More preferably however, one may develop from the aligned shapes a statistical classifier, as known in the art, which may then be applied to a new shape to derive the desired biomarker. This may involve modelling the shape variation of said aligned 2-D shapes by dimensionality reduction. Suitably, said dimensionality reduction is conducted to form a point distribution model to identify principal components of said variation.

Many suitable techniques are well known in the art for carrying out such dimensionality reduction, including principal component analysis, Kernel-PCA, Principal Geodesic Analysis, Independent Component Analysis (ICA), Locally Linear Embeddings or Φ-PCA.

Thus, the biomarker may then be obtained as the output of a classifier. Again, many suitable forms of statistical classifier are known in the art, and the classifier may by way of example be a linear classifier, a quadratic classifier, a Kernelized support vector machine, or a K-nearest neighbor classifier.

Suitably, as exemplified hereafter a quadratic Gaussian classifier is constructed based on the first n of the principal components, where n is an integer. Such a classifier may be trained on the set of 2-D shapes after alignment in accordance with the second aspect of the invention where the set of 2-D shapes includes examples of at least two classes, so as to be able to determine, or estimate the probability of, whether a new shape belongs to one class or the other. Such classes may for instance be body parts showing signs of a disease as against body parts which are free from disease, or may be body parts deriving from a patient who will or did go on to develop disease at a future time as against body parts from a patient who does not. They may represent body parts from a patient who has benefited from a treatment regime as one class and body parts from non-responding patients as another class. Thus the output from such a classifier applied to a new body part shape may be a quantitative biomarker which is diagnostic, prognostic or an efficacy of treatment marker.

Looking in more detail at typical preferred procedures, and as indicated above, for use in step (b1), a statistical model is constructed based on a multiplicity of 3-D images of the relevant body part. Said multiplicity of images constitutes a training set from which to learn the relationship between the spatial coordinates of a landmark and the relative depth of the landmark. Suitably, at least 10 images, preferably at least 20 images are used to construct the model.

The images may be 3-D scan images of any kind, such as CT images or MRI images.

From landmarks applied manually to set locations in each of a set of slices of such a 3-D image, a set of landmarks characterising the image may be constructed. It may be desirable to apply a smoothing algorithm such as an iteratively minimised smoothing function to reduce or remove spurious shape variations between the shapes.

The shapes may be aligned by an alignment algorithm such as generalised Procrustes alignment. Following this, a statistical relative depth model may be constructed to express the distribution of the relative depth of the landmarks conditioned by the x and y (spatial) coordinates.

The relative depths of the landmarks of the 2-D shapes derived from the application of the 3-D model do not directly provide the degree of rotation of the imaged body part but they do provide one additional parameter that is fed into the 2-D alignment process. Accordingly, having aligned for translation, scaling and rotation in the projection plane in the first round of the alignment process, one can perform a second round of alignment utilising the relative depth information to deal with rotation out of the projection plane.

The 2-D shapes to be aligned may be defined by a substantial number of landmark points, for instance more than 25, e.g. more than 40. Many of these may be interpolated by computer, typically at equal spacing, based on a smaller number of hand annotated landmarks.

As applied to generalised Procrustes alignment (GPA), the method of the invention is herein termed Projected generalised Procrustes alignment (PGPA).

Following alignment of the shapes according to the invention, the aligned shape information may be used as described in any of the three cases described above, i.e. WO2006/087190, WO2008/141996 and PCT/EP2009/054294 and more generally as described in any previous publication in which generalised Procrustes alignment is practised on 3-D object shapes represented as projected 2-D shapes.

Generally, the next step will be to generate a point distribution model (PDM) in which each shape is represented as a point in a vector space. Where there are n landmark points defining each shape in the population of shapes being studied and each landmark is defined in 2 dimensions by x,y coordinate values, each shape can be plotted as a single point in a 2n dimensional space. The origin can be the mean shape. The scattered cloud of points is analysable as a probability distribution using some form of dimensionality reduction method such as principal component analysis (PCA), which term is used herein to include variations of the classic PCA method. Various methods for dimensionality reduction used in producing a PDM have been identified in the introduction. Any of these may be used when forming a PDM from shapes aligned according to the invention.

The PDM may be used for outputting an estimate of the full contour of a shape contained in an image of a new example of the relevant body part based on limited starting landmark information, for instance from 3 to 10 landmark positions, as for instance in WO02008/141996.

Alternatively, the aligned shapes may be used as a training set for defining a regression model to indicate the expected shape of one body part (such as one vertebra of a patient) based on knowledge of the shape of a different but similar body part (such as a second vertebra of the patient) as in WO2006/087190.

Alternatively, the probability of a shape contained in a new example of the relevant body part belonging to a specified class of such body parts can be assessed based on a classifier constructed from an aligned training set of shapes of such body parts whose class status is known. For instance, the probability of a new vertebra shape belonging to a class of vertebrae that will suffer an osteoporotic fracture within a future period can be assessed based on a classifier constructed from a training set of images of unfractured vertebrae known to suffer such a fracture in the future, from a training set of images of unfractured vertebrae known not to suffer such a fracture in the future, or from both kinds of training sets. Suitably, such a process is conducted using any discriminant analysis or classifier, including linear discriminant analysis, quadratic discriminant analysis, penalised discriminant analysis or a non-parametric classifier. All of these are well established techniques. Such methods are exemplified in PCT/EP2009/054294.

In a further aspect, the invention provides a method of mathematical alignment of a 2-D starting shape defined by a set of landmarks derived from a 2-D projection image of a body part, said method comprising in a suitably programmed computing device:
(a) taking said starting shape and taking a pre-defined reference shape of the same kind of body part and optionally applying an algorithm to align these shapes with respect to at least one of rotation, translation and scaling;
(b) for the starting shape, inferring the relative depth of each landmark which relative depth is dependent on the extent of rotation about an axis parallel to the image projection plane of the body part that was imaged to produce the starting shape, said inference being carried out by
   (b1) deriving for each landmark of the 2-D shape a probable relative depth by the application thereto of a statistical model based on a multiplicity of 3-D shapes defined by landmarks derived from 3-D images of similar said body parts, said landmarks having one depth and two spatial coordinates, said model relating the probable relative depth of each landmark in a 3-D-shape of a said body part to the spatial coordinates of the set of landmarks constituting a said shape
(c) based on the inferred relative depth of the landmarks of the starting shape deforming the starting shape to correct for apparent distortion caused by rotation about an axis parallel to the projection plane of the imaged body part, so producing a corrected starting shape, and
   aligning the corrected starting shape with the reference shape to produce an aligned corrected starting shape. Optionally, one may further proceed by comparing the aligned corrected starting shape with the reference shape to establish a measure of the difference therebetween.

This third aspect of the invention accordingly aligns a new shape with a single reference shape and may for instance be used to compare an image taken at a later time with an image taken at an earlier time of the same body part, whilst correcting for differences in out of plane rotational attitude between the two images.

The invention includes an instruction set (which may be on a computer readable data carrier) for programming a computer to conduct the methods as described herein and includes a computer so programmed.

The invention will be further described and illustrated with reference to the accompanying drawings in which:

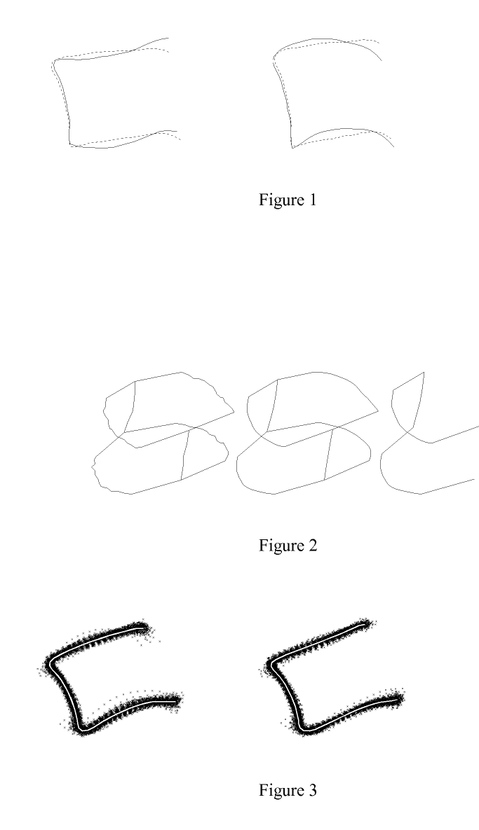

FIG. 1 shows examples of apparent deformation of the profile of a vertebra upon rotation. The dashed contour is deformed using positive (left) and negative (right) angle parameters.

FIG. 2 shows examples of 3-D vertebral shapes. Left: raw annotated shape. Middle: the same shape after smoothing. Right: subshape used to construct a relative depth model.

FIG. 3 shows landmarks of shapes aligned in a procedure described below. The white line is the mean shape. Left: GPA alignment. Right: PGPA alignment according to the invention.

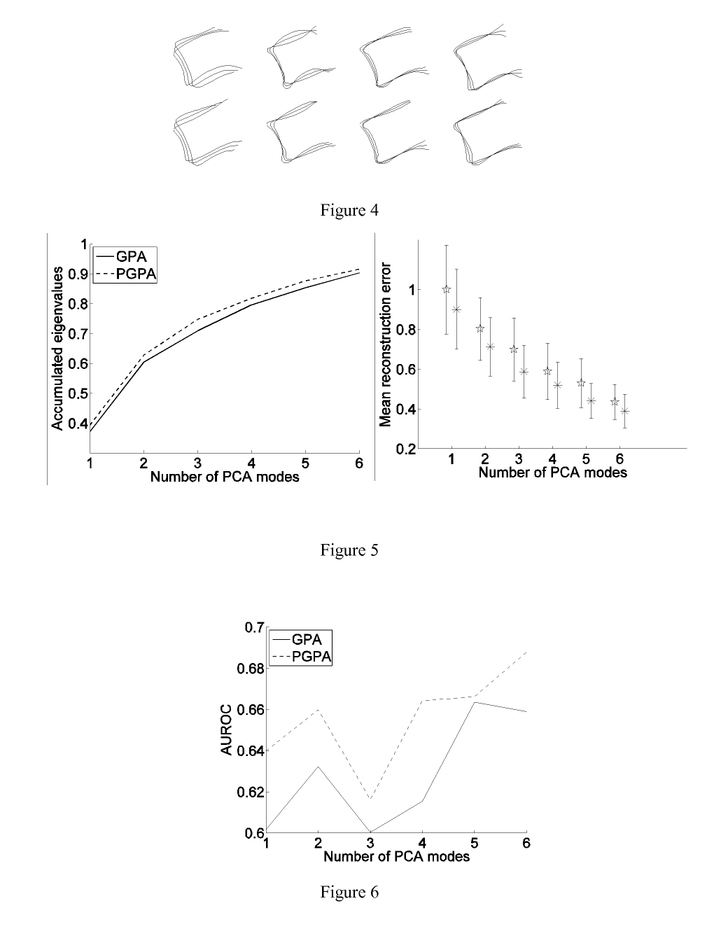

FIG. 4 shows modes of variation of a 2-D data set representing vertebra contours modeled using principle component analysis (PCA). The first four modes of variation of the GPA and PGPA aligned data are shown. Top row: modes from GPA aligned data. Bottom row: modes from PGPA aligned data.

FIG. 5 shows results from an experiment below where leave one out patient tests are performed to see how GPA and PGPA generalize when combined with PCA: Left:

Accumulated eigenvalues of the shape covariance matrix, only the 6 largest eigenvalues were used. Right: means and variances of the reconstruction errors (L2 norm of the residual) as a function of the number of PCA modes. The dashed and the solid lines correspond to PGPA and GPA data, respectively.

FIG. 6 shows AUROC as a function of the number of principal components. The dashed and the solid lines correspond to PGPA and GPA data, respectively.

There follows a description of an example of the use of the invention. The calculations described below were performed by computer. GPA as described in the introduction does not normalize for the 3-D rotation out of the 2-D projection plane. In some cases, such normalization can be performed by aligning the objects in 3-D before performing any observations, for instance by fixing the position of a body part to be X-rayed in a standard orientation. However, this may be very tedious and sometimes impossible, i.e. when observing vertebrae in X-ray images taken from scoliosis affected subjects, the individual vertebra may have varying orientations, and a single X-ray cannot capture all vertebrae in standardized position.

We propose to normalize for the 3-D orientation by modelling the apparent deformation of a set of 2-D shapes. Each shape can consist of a finite number of landmarks and the apparent deformation can be interpreted as the 2-D landmark displacement when the corresponding 3-D landmarks, are rotated with respect to the projection plane. We represent the apparent deformation by using conditional normal densities of the relative depth of 2-D shapes. In an example presented herein, the apparent deformation is used to normalize a set of 2-D vertebra shapes, and the relative depth is learned from an independent 3-D data set. Two examples of apparent deformation are shown in FIG. 1.

### Shape Model

A set of shapes can be represented by using a PDM. Thus, a single D-dimensional shape with N points can be represented by a D×N matrix, i.e. when D=3, a shape is represented by:

$$s = [ \begin{matrix}{x}_{1} & {x}_{2} & … & {x}_{N} \\ {y}_{1} & {y}_{2} & … & {y}_{N} \\ {z}_{1} & {z}_{2} & … & {z}_{N}\end{matrix} ] \qquad ( 1 )$$

A set of shapes can be aligned by performing GPA. This consists of applying a similarity transformation to maximize the inter shape similarity. This is equivalent to minimizing the inter-landmark variances by using similarity transformations, and it can be formulated as a minimization problem with the following cost function:

$$c = {\sum }_{i \neq j} ‖ {A}_{i} {s}_{i} - {A}_{j} {s}_{j} ‖ \qquad ( 2 )$$

where sᵢ is a shape and Aᵢ is a similarity transformation. Solving for the optimal Aᵢ is normally done in an iterative fashion [Cootes et al 1992].

The shape variation of a set of shapes is modelled using PCA by projecting the shapes onto the eigenvectors of the shape covariance matrix. Dimensionality is reduced by discarding eigenvectors with a small eigenvalue. The shape covariance matrix is computed using maximum likelihood estimates:

$$μ = \frac{1}{n} {\sum }_{i = 1}^{n} {s}_{i} , \\ Σ = \frac{1}{n - 1} {\sum }_{i = 1}^{n} ( {s}_{i} - μ ) {( {s}_{i} - μ )}^{T} \qquad ( 3 )$$

where sᵢ has the same form as the vectorized transpose of (1).

Here, we seek to model the shape variation of a set of vertebrae contained in a 2-D data set. A total of 76 subjects were selected from a cohort of Danish postmenopausal women who were followed for assessment of osteoporosis and atherosclerosis in the Prospective Epidemiological Risk Factors (PERF) study [Bagger et al 2006].

Lateral X-rays of the lumbar spine were obtained for each subject at a baseline and at a followup examination 7-10 years later. None of the selected subjects had any fractures at the baseline examination. A radiologist located visible fractures according to Genant's quantitative and semi-quantitative fracture scores [Wu et al 2005] and annotated the full boundary contour of lumbar vertebrae L1-L4. Subsequent computer analysis was based on a set of 50 equi-spaced landmarks generated by the computer from the hand annotations.

### 3-D Orientation

Before any sensible 3-D information can be collected from the 3-D shapes, they must be aligned. This is accomplished here by performing GPA on 3-D shapes. Thereafter, we assume that the 2-D shapes are given as orthographic projections of the 3-D shapes, and wish to model the apparent deformation. Generalizations to perspective projections are then straight forward.

If we assume that the projection plane equals the [x y]^{T} plane, then any rotation of the 3-D shapes in the [x y]^{T} plane will deform the 2-D shapes consistently with a 2-D rotation in this plane. Hence, the apparent deformation must only be learned for rotations in the [x z]^{T} and [y z]^{T} planes. These rotations can be described by the following rotation matrices:

$${R ( {θ}_{1} )}_{{[ \begin{matrix}x & z\end{matrix} ]}^{T}} = [ \begin{matrix}cos {θ}_{2} & 0 & - sin {θ}_{2} \\ 0 & 1 & 0 \\ sin {θ}_{2} & 0 & cos {θ}_{2}\end{matrix} ] , \\ {R ( {θ}_{2} )}_{{[ \begin{matrix}y & z\end{matrix} ]}^{T}} = [ \begin{matrix}1 & 0 & 0 \\ 0 & cos {θ}_{1} & - sin {θ}_{1} \\ 0 & sin {θ}_{1} & cos {θ}_{1}\end{matrix} ] \qquad ( 4 )$$

The rotation can be linearized by using the first order Taylor expansion of the rotation operation around zero:

$$\begin{matrix}R ( θ ) \approx R ( 0 ) + θ \frac{d R}{d θ} ( 0 ) \\ \approx ( I + θ \frac{d R}{d θ} ( 0 ) ) .\end{matrix} \qquad ( 5 )$$

A nice effect of the linearization is that the rotation in the [x z]^{T} and [y z]^{T} planes can be handled separately. Thus, after linearization 3-D rotations commute. This is very expedient since, infinitesimally, the commutator of a [x z]^{T} rotation and a [y z]^{T} rotation is a [x y]^{T} rotation, that is anyway handled separately in the GPA. Furthermore, it can be shown that dR/dθ (0) will be a skew symmetric matrix with zero diagonal values, which represents a Lie algebra of the 3-D rotation matrices. Thus, direct exponentiation of dR/c/θ (0) results in the original rotation matrix defined by θ, and (5) corresponds to the first two terms of the direct exponentiation. Hence, any other group of transformations to be discarded may likewise be handled based on its lie algebra formulation.

Without loss of generality, only rotation matrices that rotate in the [y z]^{T} plane are considered. The vertebra is to a first approximation a cylinder seen on edge, so rotations about the central axis of the cylinder in the [x y]_{T} plane can be ignored. Given a 3-D shape sᵢ and the 2-D landmark displacement, Dᵢ corresponding to a 3-D rotation of Sᵢ by the angle θ, the following relation can be formulated:

θDᵢ=PR₀sᵢ−Pₛ_{ᵢ} (6)

where P is an orthographic projection matrix. Equation (6) can be reduced by using (5) and rearranging the components:

$$θ {D}_{i} = P ( θ \frac{d R}{d θ} ) {s}_{i} \qquad ( 7 )$$

By canceling the rotation angle, the following is obtained:

$${D}_{i} = P ( \frac{d R}{d θ} ) {s}_{i} \qquad ( 8 )$$

Thus, for a given shape sᵢ, the linearized 2-D displacement resulting from 3-D rotation can be described by a scalar multiple of the projection of the differential rotation change in 3-D. Furthermore, by inserting the projection and rotation matrices into (8), the following is obtained:

$$P [ \begin{matrix}0 & 0 & 1 \\ 0 & 0 & 0 \\ - 1 & 0 & 0\end{matrix} ] [ \begin{matrix}{x}_{1} & {x}_{2} & … & {x}_{N} \\ {y}_{1} & {y}_{2} & … & {y}_{N} \\ {z}_{1} & {z}_{2} & … & {z}_{N}\end{matrix} ] = [ \begin{matrix}{z}_{1} & {z}_{2} & … & {z}_{N} \\ 0 & 0 & … & 0\end{matrix} ] \qquad ( 9 )$$

Thus, the necessary information required to establish a linear model of the apparent deformation is the z-coordinates of the shapes. Further-more, since θ was cancelled in (8), the apparent deformation is only dependent on the relative depth of the 2-D shapes. In practice, this means that the degree of freedom resulting from the displacement of the z-coordinates when a 3-D rotation is performed can be discarded. The relative depths can be obtained by performing GPA on the 3-D shapes.

### Relative Depth Model

In the previous section, it is shown that the apparent deformation of a 2-D shape is given by a scalar multiple of the relative depth. We employ a conditional Gaussian model to learn the relative depth given the spatial landmark coordinates. The model was based on a 3-D data set created by annotating 25 low-dose CT images of post-menopausal women. The CT scans were randomly selected from the Danish Lung Cancer Screening Trial (DLCST) [Pedersen et al 2007]. The selected subjects were not related to those in the 2-D data set described above, and the risk of them obtaining a vertebrae fracture was not assessed.

The annotations were performed by placing four landmarks in each one of a series of coronal slices: the slicing starting at the posterior and progressing in the axial plane towards the anterior of the vertebra. Connecting corresponding points from each slice creates six connected 3-D polylines. In FIG. 2, left hand picture, two of these extend vertically, one connects the top of the left vertical line to the top of the right vertical line around the front of the top of the vertebra. Another, polyline connects the top of the left vertical line to the top of the right vertical line around the front of the back of the vertebra and two corresponding lines extend around the bottom. However, a combination consisting of only three polylines corresponds to the 2-D vertebra shapes obtained from the 2-D data set. An example of the 3-D annotation is shown in the left of FIG. 2.

To remove spurious shape variation, the annotated shapes were smoothed by minimizing an internal energy function. We have defined a simple energy function based on co-linearity of the shape points:

$$E ( s ) = {\sum }_{n = 1}^{N - 1} d ( {s}_{n} , {s}_{n + 1} ) \qquad ( 14 )$$

where s is a shape, N is the number of points in the shape, and d(x1, x2) is the L2 norm.

This energy function can be minimized iteratively by a gradient descent algorithm:

$$∇ s = - γ \frac{\partial E ( s )}{\partial s} \qquad ( 15 )$$

where the constant γ>0 is the learning rate.

By denoting the shapes at times t and t+1 by s^{t} and by s^{t+1}, respectively, and using a finite difference scheme, Equation (15) can be rewritten and solved for s^{t+1}:

$${s}^{t + 1} = {s}^{t} - γ \frac{\partial E ( s )}{\partial s} \qquad ( 16 )$$

To impose some degree of regularity, a fixed number of gradient descent steps based on the internal energy is performed (we have used t^{max}=20 with γ=½). However, a combined energy that also accounts for the deviation from the original data could have been used [Chemo et al 2009].

We are interested in the distribution of the relative depth d conditioned by the x and y coordinates:

P(d|x,y) (10)

When it is assumed that the distribution of the x and y coordinates, and the relative depth are both Gaussian, the probability distribution function (10) is also Gaussian with a closed form solution [Bishop et al 2006].

Let Σ denote a 3n×3n covariance matrix. Then, it can be partitioned into four submatrices:

$$Σ = [ \begin{matrix}{Σ}_{11} & {Σ}_{12} \\ {Σ}_{21} & {Σ}_{22}\end{matrix} ] \qquad ( 11 )$$

where the sub-matrices Σ₁₁ and Σ₂₂ correspond to the covariance matrix of the depth and the covariance matrix of the spatial landmark coordinates, respectively.

The mean of P(z) conditioned by P(x; y) can be expressed as [Bishop et al 2006]:

p_{d|x,y}=pₛ+Σ₁₂Σ₂₂⁻¹(s−μ_{x,y}) (12)

However, due to the lack of data, Σ₂₂ may be badly estimated and ill-conditioned or singular. In that case, ridge regression [Bishop et al] can be used to regularize the co-variance matrix.

The covariance and mean matrices can be computed by using maximum likelihood methods analogous to (3). However, in practice, only a few shapes may be available, and each shape may consist of many points. Thus, to avoid the curse of dimensionality, some correlations must be removed from the model.

We propose to estimate the depth independently by having a separate depth model for each landmark. If the set of all landmark indexes is denoted by L, and a subset of these indexes is denoted by L_{sub}, the following model is constructed:

P(dⱼ|xᵢl/i) (13)

where dⱼ is the relative depth of the jth landmark, j ∈ L_{sub}, ∀i ∈ L_{sub} ∈L. Decreasing the subset L_{sub} decreases the number of correlations in Σ. Our implementation uses 1+2k landmarks for each depth model, where k is the number of neighboring points to each side of the j'th landmark.

This results in a globally consistent model that estimates the relative depth when given a set of landmarks. The apparent deformation is performed by adding the recovered relative depth to the shape coordinates. Furthermore, several depth models can be used to infer the relative depth. This may be necessary when the 3-D and 2-D shapes are not completely consistent with each other, as it is the case with the vertebrae shapes we use here. In this case, the multiple estimates of the relative depth are weighted equally when being added with the landmark coordinates, and the sub-shapes are positioned correctly using similarity transformations. This transforms the apparent deformation to a nonlinear process.

Before evaluating (13) to obtain the depth, the x and y coordinates are aligned with the landmark coordinates used in the depth model. Furthermore, since a 3-D rotation around the center not included in the 2-D projection plane will generally also encompass an apparent translation, GPA is used to align shapes corrected for apparent deformation.

By combining the method described above relating to the relative depth model with GPA, a set of shapes can be aligned. The resulting Projected Generalized Procrustes Alignment (PGPA) procedure may be generally outlined in the following steps:
1. Perform GPA and define the reference shape to be the mean shape.
2. For each shape sᵢ do:
   infer the relative depth dᵢ using the relative depth model described above.
   perform apparent deformation by using the relative depth dᵢ to maximize the similarity between sᵢ and sᵣₒₜₘₑₐₙ
3. Perform GPA to align the deformed 2D shapes.
4. Calculate a new mean shape, align it with the reference shape, and use it as a new reference shape sᵣₒₜₘₑₐₙ.
5. Terminate if the reference shape has changed less than some threshold ε, otherwise go to step 2.

The mean 2D shape can be used as an initial estimate of the shape sᵣₒₜₘₑₐₙ. However, due to the linearity approximation of the 3D rotation, the 3D orientation alignment will break down for large angles. A simple approach is to constrain the θ parameter with an upper and a lower bound when calculating srotmean. Once srotmean is calculated, the upper and lower bounds may be relaxed.

FIG. 1 shows the apparent deformation for a single 2-D shape. It is seen that the vertebra shape appears to deform consistently with a rotation of the corresponding 3-D shape.

FIG. 3 shows an example of the PGPA and GPA applied to the whole 2-D data set. Not surprisingly, since the shapes were deformed while maximizing the inter-shape similarity, the shapes in the PGPA aligned shapes have a smaller inter landmark variance than those aligned by GPA. The mean shape implied by PGPA appears less curved and more symmetric than the mean shape implied by the GPA. This suggests that the PGPA calculates plausible mean shapes. There is smaller inter landmark variance and a simpler and more symmetric mean shape in the PGPA alignment.

FIG. 4 shows the first four modes of variation for the shapes aligned by GPA and PGPA. Generally, the modes of variation obtained from the shapes aligned by PGPA are more compact in terms of inter-landmark variance and encode more complex shape variations when compared to the modes obtained from the shapes aligned by GPA. The difference between the second mode of variation is especially noticeable: in the GPA aligned data, the second mode seems to be related to the apparent deformation due to a 3-D rotation being more similar to the apparent deformation than is the PGPA aligned data.

For further investigations of the shape variability of GPA and PGPA aligned data, eigenvalue decomposition of the shape covariance matrix was performed. The normalized, sorted, and accumulated eigenvalues are shown in the left part of FIG. 5. It is seen that the PGPA eigenvectors are able to capture more variation of the data when compared to the traditional GPA eigenvectors.

Leave-one patient-out tests were performed to see how the GPA and PGPA generalize when combined with PCA. The right part of FIG. 5 shows the mean and the variance of the reconstruction errors when reconstructing unseen vertebrae shapes. The reconstruction errors were computed as the L2 norm of the residuals. It is seen that using PGPA improves both the mean and variance of the reconstruction errors by roughly 10 percent.

As a conclusion, PGPA implies a more compact model that generalizes better on this data set.

### Vertebra Fracture Prediction

Above, the modeling capabilities of the PGPA were assessed. Here, we perform a fracture risk experiment to asses—to which degree the PGPA also captures the clinically relevant information.

At baseline, all vertebrae were healthy according to Genant's quantitative and semi-quantitative fracture scores. We perform an experiment to see to which degree these healthy shapes can be classified into: those that fracture before follow-up and those that remain healthy.

As Osteopathis has both a systemic and localized component, we discard all vertebrae that remain healthy, but originate from subjects obtaining at least one fracture. This leaves 38 vertebrae that fracture and 160 vertebrae that remain healthy. A quadratic Gaussian classifier is constructed based on these components. The receiver operating characteristic (ROC) curves and the corresponding area under ROC (AUROC) curves were calculated as a function of the number of principal components that were used when the dimensionality of the data was reduced. The results are shown in FIG. 6.

In our cases, the PGPA provides slightly superior predictive power. This shows that removing the apparent deformation not only makes the model more compact and generalize better, but it also improves the capability to capture the clinically relevant information.

We have proposed a method that aligns shapes by using a statistical model of the relative depth. Compared to GPA, out method gives a performance boost when performing vertebra shape modeling and when assessing vertebra fracture risk.

Visual inspection of the modes of variation of PGPA and the apparent deformation give intuitive results: the apparent deformation looks as if originating from a 3-D rotation and when compared to GPA, the modes of variation are more compact and have a superior generalization to unseen shapes.

Furthermore, the improvements obtained when predicting vertebra fractures suggest that PGPA does not introduce large modeling errors. On the contrary, it suggests that the resulting shape model captures the clinically relevant information better.

Although the specific example given above has applied the techniques of the invention to images of vertebrae, it should be appreciated that this is purely by way of example and the same techniques can be applied to a wide variety of different body parts in order to extract clinically significant information therefrom.

In this specification, unless expressly otherwise indicated, the word ‘or’ is used in the sense of an operator that returns a true value when either or both of the stated conditions is met, as opposed to the operator ‘exclusive or’ which requires that only one of the conditions is met. The word ‘comprising’ is used in the sense of ‘including’ rather than in to mean ‘consisting of’. All prior teachings acknowledged above are hereby incorporated by reference in their entirety. No acknowledgement of any prior published document herein should be taken to be an admission or representation that the teaching thereof was common general knowledge in Australia or elsewhere at the date hereof.

### REFERENCES

Bagger, Y. Z., Tankó, L. B., Alexandersen, P., Hansen, H. B., Qin, G., Christiansen, C.: The long-term predictive value of bone mineral density measurements for fracture risk is independent of the site of measurement and the age at diagnosis: results from the prospective epidemiological risk factors study. Osteoporosis International 17 (2006) 1433-2965
Benameur, S., Mignotte, M., Parent, S., Labelle, H., Skalli, W., de Guise, J.: 3-D/2-D registration and segmentation of scoliotic vertebrae using statistical models.
Bishop, C. M.: Pattern Recognition and Machine Learning (Information Science and Statistics). Springer-Verlag New York, Inc (2006)
Buxton, B. F., Dias, M. B.: Implicit, view invariant, linear exible shape modelling. Pattern Recognition Letters 26 (2005) 433-447 Computerized Medical Imaging and Graphics 27(5) (2003) 321 {337
Cherno, K., Nielsen, M.: Regularization based on local models. Submitted as technical report April 2009, Department of Computer Science, Copenhagen University
Cootes, T. F., Cooper, D. H., Taylor, C. J., Graham, J.: Trainable method of parametric shape description. Image Vision Comput. 10 (1992) 10289-294
Cootes, T. F., Taylor, C. J.: Statistical models of appearance for computer vision (1999) Technical report, University of Manchester, Wolfson Image Analysis Unit.
Cootes, T. F., Hill, A., Taylor, C. J., Haslam, J.: The use of active shape models for locating structures in medical images. Image and Vision Computing 12(3) (1994) 355-366
Crimi, A., Ghosh, A., Sporring, J., Nielsen, M.: Bayes Estimation of Shape-models with Application to Vertebrae Boundaries. In Proceedings of SPIE. Volume 7259. (2009)
Davies, R. H., Cootes, T. F., Taylor, C. J.: A minimum description length approach to statistical shape modelling. In: IPMI. Volume 2082. (2001) 50-63
Dam, E., Fletcher, P. T., Pizer, S. M., Tracton, G., Rosenman, J.: Prostate shape modeling based on principal geodesic analysis bootstrapping. In: MICCAI. (2004)
de Bruijne, M., Nielsen, M.: Shape particle filtering for image segmentation. In: Medical Image Computing and Computer-Assisted Intervention. (2004) 168-175
de Bruijne, M., Lund, M. T., Tankob, L. B., Pettersen, P. C., Nielsen, M.: Quantitative vertebral morphometry using neighbor-conditional shape models. Medical Image Analysis 11 (2007) 503-512
Elgammal, A.: Nonlinear generative models for dynamic shape and dynamic appearance. In: Computer Vision and Pattern Recognition Workshop. Volume 27. (2004) 182-182
Goodall C. 1991, Procrustes methods in the statistical analysis of shape, J. Roy. Statist. Soc. Ser. B (Methodological) 53, (2), 285-239
Gower J. C. 1975, Geralised Procrustes Analysis. Psychometrika 40, 33-51
Iglesias, J. E., de Bruijne, M., Loog, M., Lauze, F., Nielsen, M.: A family of principal component analyses for dealing with outliers. In: MICCAI. Volume 4792. (2007) 178-185
Larsen, R.: L1 generalized procrustes 2-D shape alignment. Journal of Mathematical Imaging and Vision 32 (2008) 189{194
Larsen, R.: Functional 2-D procrustes shape analysis. In: Image Analysis. Volume 3540. Springer Berlin/Heidelberg (2005) 205-213
Larsen, R., Eiriksson, H.: Robust and resistant 2-D shape alignment. Technical report, Informatics and Mathematical Modelling Technical University of Denmark (2001)
Pedersen, J. H., Dirksen, A., Hansen, H., Bach, K. S., Tonnesen, P., Brodersen, J., Thorsen, H., Skov, B. G., Mortensen, J., Dossing, M.: The danish randomized lung cancer ct screening trial. results at baseline: A7-01. Thoracic Oncology 2 (August 2007) 329
Roberts, M. G., Cootes, T., Adams, J.: Automatic segmentation of lumbar vertebrae on digitised radiographs using linked active appearance models. In: Proc of MIUA Conference. (2006)
Romdhani, S., Gong, S., Psarrou, R.: A multi-view nonlinear active shape model using kernel pca. In: British Machine Vision Conference. (1999) 483-492
Siegel, A. F., Benson, R. H.: A robust comparison of biological shapes. Biometrics 38 (1982) 341-350
Smyth, P., Taylor, C., Adams, J.: Vertebral shape: Automatic measurement with active shape models. Radiology 2 (1999) 571-578
Tipping, M. E., Bishop, C. M.: Probabilistic Principal Component Analysis. In J. R. Statist. Soc. B, 61(3):611-622. (1999)
Uzümcü, M., Frangi, A. F., Reiber, J. H., Lelieveldt, B. P.: Independent component analysis in statistical shape models. In: Proceedings of SPIE. Volume 5032. (2003) 375-383

Wu, C. Y., Li, J., Jergas, M., Genant, H. K.: Comparison of semiquantitative and quantitative techniques for the assessment of prevalent and incident vertebral fractures. Osteoporosis International 5(5) (2005) 354-370

1. A method of manipulation of a representation of a 2-D shape, comprising taking a starting 2-D shape defined by a set of landmarks derived from data representing a 2-D projection image of a body part, in a suitably programmed computing device deriving for each landmark of the 2-D shape a probable relative depth by the application thereto of a statistical model based on a multiplicity of 3-D shapes defined by landmarks derived from 3-D images of similar said body parts, said landmarks having one depth and two spatial coordinates, said model relating the probable relative depth of each landmark in a 3-D-shape of a said body part to the spatial coordinates of the set of landmarks constituting a said shape, and based on the inferred relative depth of the landmarks of the starting 2-D shape deforming the starting 2-D shape to correct for apparent distortion caused by rotation about an axis parallel to the projection plane of the imaged body part, so producing a corrected 2-D shape.

2. A method of mathematical alignment of a set of alignable 2-D shapes, each shape being defined by a set of landmarks derived from data representing a 2-D projection image of a body part, said method comprising in a suitably programmed computing device:
(a) executing an algorithm on the set of shapes to align said shapes with respect to at least one of translation, scaling and rotation and to define a reference shape being a mean of said shapes aligned with respect to at least one of translation, scaling and rotation within an image projection plane;
(b) for each aligned shape in the set of 2-D shapes, inferring the relative depth of each landmark which is dependent on the extent of rotation of the body part that has been imaged to produce the shape about an axis parallel to the image projection plane, said inference being carried out by
(b1) deriving for each landmark of the 2-D shape a probable relative depth by the application thereto of a statistical model based on a multiplicity of 3-D shapes defined by landmarks derived from said body parts, said landmarks having one depth and two spatial coordinates, said model relating the probable relative depth of each landmark in a 3-D-shape of a said body part to the spatial coordinates of the set of landmarks constituting a said shape
(c) based on the inferred relative depth of the landmarks of each of the aligned 2-D shapes deforming the 2-D shape to correct for apparent distortion caused by rotation of the imaged body part about an axis parallel to the projection plane
(d) executing an algorithm to align the corrected shapes,
(e) calculating a corrected reference shape, being the mean of the corrected shapes and aligning the corrected reference shape with the preceding reference shape to produce a new reference shape,
(f) repeating from step (b) until the new reference shape and the preceding reference shape are close to being the same within a predetermined limit, and so obtaining a set of 2-D-shapes aligned with respect to at least one of translation, scaling, rotation within the projection plane and aligned with respect to rotation out of the projection plane.

3. A method as claimed in claim 1 or, wherein said 3-D shapes are derived from data representing respective 3-D images of said body parts.

4. A method as claimed in claim 1, wherein a separate statistical model is used for each landmark of the 2-D shape.

5. A method as claimed in claim 1, wherein the statistical model is a conditional Gaussian model

6. A method as claimed in claim 1, wherein the probable relative depth of each landmark of the 2-D shape is based on the covariance matrix of the spatial landmark coordinates of the multiplicity of 3-D shapes.

7. A method as claimed in claim 6, wherein the probable relative depth of each landmark of the 2-D shape is based on an estimate of the covariance matrix.

8. A method as claimed in any claim 2, wherein in step (d) the 2-D shapes are corrected for deformation produced by rotation of the imaged body part by adjusting the 2-D spatial coordinates of each landmark according to its calculated probable relative depth.

9. A method as claimed in claim 1, wherein the or each body part in said images is a bone, a joint, or a part of a joint including at least a part of at least one bone.

10. A method as claimed in claim 9, wherein the or each said body part is a vertebra.

11. A method as claimed in claim 2, further comprising modelling the shape variation of said aligned 2-D shapes by dimensionality reduction.

12. A method as claimed in claim 11, wherein said dimensionality reduction is conducted to form a point distribution model to identify principal components of said variation.

13. A method as claimed in claim 12, wherein said dimensionality reduction is carried out by principal component analysis, Kernel-PCA, Principal Geodesic Analysis, Independent Component Analysis (ICA), Locally Linear Embeddings or Φ-PCA.

14. A method as claimed in claim 2, further comprising deriving from data defining an aligned shape at least one prognostic, diagnostic or efficacy biomarker relating said shape to a future or present disease state or to a change in a disease state.

15. A method as claimed in claim 14, wherein said biomarker is obtained as the output of a classifier.

16. A method as claimed in claim 15, wherein said classifier is a linear classifier, a quadratic classifier, a Kernelized support vector machine, or a K-nearest neighbor classifier.

17. A method as claimed in claim 16, wherein a quadratic Gaussian classifier is constructed based on the first n of the principal components, where n is an integer.

18. A method of mathematical alignment of a 2-D starting shape defined by a set of landmarks derived from a 2-D projection image of a body part, said method comprising in a suitably programmed computing device:
(a) taking said starting shape and taking a pre-defined reference shape of the same kind of body part;
(b) for the starting shape, inferring the relative depth of each landmark which relative depth is dependent on the extent of rotation about an axis parallel to the image projection plane of the body part that was imaged to produce the starting shape, said inference being carried out by
(b1) deriving for each landmark of the 2-D shape a probable relative depth by the application thereto of a statistical model based on a multiplicity of 3-D shapes defined by landmarks derived from 3-D images of similar said body parts, said landmarks having one depth and two spatial coordinates, said model relating the probable relative depth of each landmark in a 3-D-shape of a said body part to the spatial coordinates of the set of landmarks constituting a said shape
(c) based on the inferred relative depth of the landmarks of the starting shape deforming the starting shape to correct for apparent distortion caused by rotation about an axis parallel to the projection plane of the imaged body part, so producing a corrected starting shape, and
aligning the corrected starting shape with the reference shape to produce an aligned corrected starting shape.

19. A method as claimed in claim 18, further comprising:
comparing the aligned corrected starting shape with the reference shape to establish a measure of the difference therebetween.

20. A method as claimed in claim 2, wherein in step b1, a separate statistical model is used for each landmark of the 2-D shape.
